(19) United States
(12) Patent Application Publication
(10) Pub. No.: US 2016/0237219 A1
(43) Pub. Date: Aug. 18, 2016

(54) TRIBLOCK DIENE ELASTOMER WHERE THE CENTRAL BLOCK IS A POLYETHER BLOCK AND THE CHAIN ENDS ARE AMINE-FUNCTIONALISED

(71) Applicants: COMPAGNIE GENERALE DES ETABLISSEMENTS MICHELIN, Clermont Ferrand (FR); MICHELIN RECHERCHE ET TECHNIQUE, S.A., Granges-Paccot (CH)

(72) Inventors: Charlotte DIRE, Clermont-Ferrand (FR); Jean Marc MARECHAL, Clermont-Ferrand (FR); Nicolas SEEBOTH, Clermont-Ferrand (FR)

(73) Assignees: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(21) Appl. No.: 15/024,136

(22) PCT Filed: Sep. 24, 2014
(86) PCT No.: PCT/EP2014/070403

§ 371 Date: Mar. 23, 2016

(30) Foreign Application Priority Data
Sep. 27, 2013 (FR) 1359352

(51) Int. Cl. C08G 81/02; C08K 3/36

(52) U.S. Cl. CPC C08G 81/025; C08K 3/36

(57) ABSTRACT

The invention relates to a triblock diene elastomer, the central block of which is a polyether block having a number-average molecular weight ranging from 150 to 5000 g/mol and is connected via a silicon atom to each of the lateral blocks, and the chain ends of which are functionalized to at least 70 mol %, with respect to the number of moles of chain end, by an amine function.

This application is a 371 national phase entry of PCT/EP2014/070403, filed 24 Sep. 2014, which claims benefit of French Patent Application No. 1359352, filed 27 Sep. 2013, the entire contents of which are incorporated herein by reference for all purposes.

### BACKGROUND

1. Technical Field

The invention relates to a triblock diene elastomer, the central block of which is a polyether block and the chain ends of which are functionalized by an amine function. The invention also relates to a process for the preparation of such a triblock diene elastomer, to a composition comprising it, and to a semi-finished article and a tire comprising this composition.

2. Related Art

Now that savings in fuel and the need to protect the environment have become a priority, it is desirable to produce mixtures having good mechanical properties, in particular good stiffness and a hysteresis which is as low as possible, in order to be able to process them in the form of rubber compositions which can be used in the manufacture of various semi-finished products participating in the composition of tire casings, such as, for example, underlayers, sidewalls or treads, and in order to obtain tires having a reduced rolling resistance.

The reduction in the hysteresis of the mixtures is an ongoing objective which has, however, to be done while retaining the suitability for processing, in particular in the raw state, of the mixtures.

Many solutions have already been experimented with in order to achieve the objective of a fall in hysteresis. Mention may in particular be made of the modification of the structure of diene polymers and copolymers for the purpose of polymerization by means of functionalization agents or else the use of functional initiators, the aim being to obtain a good interaction between the polymer, thus modified, and the filler, whether carbon black or a reinforcing inorganic filler.

In the context of mixtures comprising a reinforcing inorganic filler, provision has been made to use diene copolymers having a polyether block.

Mention may be made, by way of example, of Patent EP 1 127 909 B1, which describes a process for the preparation and the use in a vulcanizable rubber composition of a diene copolymer having a polyether block at the chain end. This copolymer is intended to interact with the reinforcing inorganic filler, so as to decrease the hysteresis of the mixture. The process for the preparation of this copolymer comprises a method of grafting the complex polyether block in three stages: i) functionalization of the ends of living polymer chains by a cyclic organosiloxane compound, in order to form a living diene elastomer having a silanolate chain end, ii) reaction of the living polymer thus functionalized with a dialkyldihalosilane and then iii) reaction of this Si—X functionalized polymer (X being a halogen) with a polyethylene glycol in the presence of dimethylaminopyridine. It is apparent that the hysteresis properties of the rubber composition comprising this polymer are significantly improved in comparison with a composition comprising a non-functional elastomer. Nevertheless, this decrease in the hysteresis can be accompanied by a decrease in the stiffness. In addition, the process of the synthesis of the block copolymer is complex.

U.S. Pat. No. 6,518,369 B2 provides a reinforced rubber composition comprising a diene copolymer having a polyether block, and also a process for the preparation of said copolymer. The solution selected consists in reacting the ends of living polymer chains with a specific polyether. Although providing an improvement in the degree of grafting to the polymer chains prepared in solution, this degree remains unsatisfactory with the process described in the patent. In point of fact, the grafting yield of the polyether block is determining for the quality of the interaction of the block copolymer with the reinforcing filler in a reinforced rubber composition and thus for the hysteresis of this composition.

Finally, mention may be made of Patent FR 2 918 064 B1 on behalf of the Applicant Company, which describes a process for the preparation and the use in a vulcanizable rubber composition of a diene copolymer having a polyether block. The process for the preparation of this copolymer comprises a simplified two-stage method of grafting the polyether block, with a greater yield than the process provided in U.S. Pat. No. 6,518,369 B2. This process comprises: i) the functionalization of the ends of living polymer chains with a cyclic organosiloxane compound, in order to form a living diene elastomer having a silanolate chain end, and ii) the reaction of the living polymer, thus functionalized, with an Si—X functionalized polyether (X=halogen or OR). However, the improvement in the hysteresis is accompanied by a decrease in the stiffness.

These functionalized elastomers have been described in the prior art as effective in reducing hysteresis. Nevertheless, it turns out that the compositions comprising elastomers thus modified do not always exhibit a hysteresis which is satisfactory and mechanical properties which are satisfactory for use in a tire tread.

For this reason, research studies have been carried out on other functionalization reactions for the purpose of obtaining rubber compositions having an improved hysteresis/stiffness compromise.

### SUMMARY

The aim of the present invention is thus to provide such a composition. One objective is in particular to provide a functionalized elastomer which interacts satisfactorily with the reinforcing filler of a rubber composition containing it in order to minimize the hysteresis thereof, while retaining an acceptable raw processing and a satisfactory stiffness, for the purpose in particular of use in a tire tread.

This aim is achieved in that the inventors have just discovered, surprisingly, during their research studies, that a triblock diene elastomer, the central block of which is a polyether block and the two chain ends of which are functionalized to at least 70 mol % by an amine function, confers, on the compositions comprising it, a noteworthy and unexpected improvement in the hysteresis/stiffness/raw processing compromise.

This is because, on the one hand, the hysteresis/stiffness compromise of such compositions is improved with respect to that of the compositions comprising elastomers not having an amine function at the chain end, in particular with respect to that of compositions comprising triblock diene elastomers, the central block of which is a polyether block, but not having an amine function at the chain end. On the other hand, the raw processing of such compositions is similar to that of a composition comprising non-functionalized elastomers and remains acceptable.

A subject-matter of the invention is thus a triblock diene elastomer, the central block of which is a polyether block having a number-average molecular weight ranging from 150 to 5000 g/mol and is connected via a silicon atom to each of the lateral blocks, and the chain ends of which are functionalized to at least 70 mol %, with respect to the number of moles of chain end, by an amine function.

Another subject-matter of the invention is a process for the synthesis of the said triblock diene elastomer.

Another subject-matter of the invention is a reinforced rubber composition based on at least one reinforcing filler and on an elastomer matrix comprising at least the said triblock diene elastomer.

### BRIEF DESCRIPTION OF THE DRAWINGS

FIGS. 1 and 2 show the dynamic properties and the Mooney viscosity of compositions comprising different diene elastomers.

### DETAILED DESCRIPTION OF EXAMPLE EMBODIMENTS

In the present description, unless expressly indicated otherwise, all the percentages (%) shown are % by weight. Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

The term “functionalization of the chain ends to at least 70 mol % by an amine function” is understood to mean a molar degree of functionalization at the chain end of at least 70%, with respect to the number of moles of chain end. In other words, after the polymerization of the monomers, at least 70 mol % of the living chains synthesized bear, at the non-reactive end of the chain, an amine function resulting from the polymerization initiator.

This thus means that at least 70 mol % of the chain ends of the triblock diene elastomer which is a subject-matter of the invention are functionalized by an amine function.

The expression “composition based on” should be understood as meaning a composition comprising the mixture and/or the reaction product of the various constituents used, some of these base constituents being capable of reacting or intended to react with one another, at least in part, during the various phases of manufacture of the composition, in particular during the crosslinking or vulcanization thereof.

The term “diene elastomer” should be understood, in a known way, as meaning an (one or more is understood) elastomer resulting at least in part (i.e., a homopolymer or a copolymer) from diene monomers (monomers bearing two conjugated or non-conjugated carbon-carbon double bonds). More particularly, the term “diene elastomer” is understood to mean any homopolymer obtained by polymerization of a conjugated diene monomer having from 4 to 12 carbon atoms or any copolymer obtained by copolymerization of one or more conjugated dienes with one another or with one or more vinylaromatic compounds having from 8 to 20 carbon atoms. In the case of copolymers, the latter comprise from 20% to 99% by weight of diene units and from 1% to 80% by weight of vinylaromatic units.

The following in particular are suitable as conjugated dienes which can be used in the process in accordance with an embodiment of the invention: 1,3-butadiene, 2-methyl-1,3-butadiene, 2,3-di(C₁ to C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, phenyl-1,3-butadiene, 1,3-pentadiene and 2,4-hexadiene, and the like.

The following in particular are suitable as vinylaromatic compounds: styrene, ortho-, meta- or para-methylstyrene, the “vinyltoluene” commercial mixture, para-(tert-butyl)styrene, methoxystyrenes, vinylmesitylene, divinylbenzene and vinylnaphthalene.

The diene elastomer of the composition in accordance with an embodiment of the invention is preferably selected from the group of highly unsaturated diene elastomers consisting of polybutadienes (BRs), synthetic polyisoprenes (IRs), butadiene copolymers, in particular copolymers of butadiene and of a vinylaromatic monomer, isoprene copolymers and the mixtures of these elastomers. Such copolymers are more particularly butadiene/styrene copolymers (SBRs), isoprene/butadiene copolymers (BIRs), isoprene/styrene copolymers (SIRs) and isoprene/butadiene/styrene copolymers (SBIRs). Among these copolymers, butadiene/styrene copolymers (SBRs) are particularly preferred.

The triblock diene elastomer according to an embodiment of the invention preferably corresponds to the following formula (I):

R₁-(A′)₂

in which:

R₁ represents a C₁-C₁₅ divalent alkyl, C₆-C₁₅ aryl or C₇-C₁₅ aralkyl hydrocarbon derivative,

each A′ represents, identically or differently, the group of general formula (II):

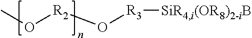

in which:

R₂ represents a divalent C₁-C₁₀ alkyl radical, in particular the —CH(R₆)—CH(R₇)— radical, in which R₆ and R₇ are, independently of one another, a hydrogen atom or a C₁-C₄ alkyl radical,

R₃ represents a C₁-C₅₀ divalent alkyl, C₆-C₅₀ aryl or C₇-C₅₀ aralkyl radical,

R₄ represents a C₁-C₅₀ alkyl, C₆-C₅₀ aryl or C₇—O₅₀ aralkyl radical,

R₈ represents a hydrogen atom or a C₁-C₁₈ alkyl, C₅-C₁₈ cycloalkyl or C₆-C₁₈ aryl radical,

n is a number greater than 1,

i is an integer varying from 0 to 2,

B represents the —[(O—SiR₉R₁₀)_{q}—P] group, in which R₉ and R₁₀ represent, independently of one another, a C₁-C₅₀ alkyl, C₆-C₅₀ aryl or C₇-C₅₀ aralkyl radical, q is an integer ranging from 0 to 10 and P is a diene elastomer functionalized to at least 70 mol % at the chain end by an amine function.

According to advantageous alternative forms of the invention, which are separate but which can be combined with one another:
R₁ represents a C₁-C₄ alkyl radical, preferably a —CH₂—CH₂— or —CH₂—CH(CH₃)— group,
R₂ is an ethylene or propylene radical, preferably an ethylene radical,
R₃ represents a C₁-C₁₀ alkyl group, preferably the linear divalent C₃ alkyl radical,
R₄ represents a C₁-C₁₀ alkyl radical, preferably the methyl radical,
R₈ represents a hydrogen atom or a C₁-C₄ alkyl radical; preferably, R₈ represents a hydrogen atom or a methyl or ethyl radical,
n is a number of less than 120, preferably a number varying from 2 to 60,
i is an integer equal to 0 or 1,
R₉ and R₁₀ represent, independently of one another, a C₁-C₁₀ alkyl radical, preferably the methyl radical,
q is a nonzero integer, preferably equal to 1.

The polyether central block preferably exhibits a number-average molecular weight ranging from 150 to 3000 g/mol and better still from 200 to 3000 g/mol.

According to another embodiment, which can be combined with the preceding ones, the triblock diene elastomer according to an embodiment of the invention is functionalized to 100% at the chain end by an amine function.

The triblock diene elastomer according to an embodiment of the invention can be prepared according to a process including the modification of the elastomer by reaction of a living diene elastomer with an appropriate functionalization agent, that is to say a polyether which is at least functional at each chain end, for the purpose of coupling, the function being any type of chemical group known by a person skilled in the art to react with a living chain end. Such a process also forms the subject-matter of the invention.

Thus, according to an embodiment of the invention, the triblock diene elastomer is obtained by the use of the following stages:
anionic polymerization of at least one conjugated diene monomer in the presence of a polymerization initiator having an amine function,
modification of the living diene elastomer bearing an active site obtained in the preceding stage by a functionalization agent, capable of coupling the elastomer chains, bearing a polyether block having a number-average molecular weight ranging from 150 to 5000 g/mol, with a molar ratio of the functionalization agent to the polymerization initiator with a value ranging from 0.40 to 0.60.

The polymerization initiators comprising an amine function result in living chains having an amine group at the non-reactive end of the chain.

Mention may preferably be made, as polymerization initiators comprising an amine function, of lithium amides, the products of the reaction of an organolithium compound, preferably an alkyllithium compound, and of a non-cyclic or cyclic, preferably cyclic, secondary amine.

Mention may be made, as secondary amine which can be used to prepare the initiators, of dimethylamine, diethylamine, dipropylamine, di(n-butyl)amine, di(sec-butyl)amine, dipentylamine, dihexylamine, di(n-octyl)amine, di(2-ethylhexyl)amine, dicyclohexylamine, N-methylbenzylamine, diallylamine, morpholine, piperazine, 2,6-dimethylmorpholine, 2,6-dimethylpiperazine, 1-ethyl-piperazine, 2-methylpiperazine, 1-benzylpiperazine, piperidine, 3,3-dimethylpiperidine, 2,6-dimethylpiperidine, 1-methyl-4-(methyl-amino)piperidine, 2,2,6,6-tetramethylpiperidine, pyrrolidine, 2,5-dimethylpyrrolidine, azetidine, hexamethyleneimine, hepta-methyleneimine, 5-benzyloxyindole, 3-azaspiro[5.5]undecane, 3-azabicyclo[3.2.2]nonane, carbazole, bistrimethylsilylamine, pyrrolidine and hexamethyleneamine.

The secondary amine, when it is cyclic, is preferably chosen from pyrrolidine and hexamethyleneamine.

The alkyllithium compound is preferably ethyllithium, n-butyllithium (n-BuLi), isobutyllithium, and the like.

Preferably, the polymerization initiator comprising an amine function is soluble in a hydrocarbon solvent without use of a solvating agent.

The polymerization initiator comprising an amine function is a reaction product of an alkyllithium compound and of a secondary amine. Depending on the molar ratio of the alkyllithium compound to the secondary amine, the product of the reaction can comprise residual alkyllithium compound. Consequently, the polymerization initiator can be composed of a mixture of lithium amide and residual alkyllithium compound. This residual alkyllithium compound results in the formation of living chains not bearing an amine group at the chain end. According to an embodiment of the invention, the polymerization initiator does not comprise more than 30% of alkyllithium compound. Above this value, the desired technical effects, in particular the improvement in the compromise between hysteresis and stiffness properties, are not satisfactory. According to an alternative form of the process, the polymerization initiator does not comprise alkyllithium compound.

The polymerization is preferably carried out in the presence of an inert hydrocarbon solvent which can, for example, be an aliphatic or alicyclic hydrocarbon, such as pentane, hexane, heptane, isooctane, cyclohexane or methylcyclohexane, or an aromatic hydrocarbon, such as benzene, toluene or xylene.

The polymerization can be carried out continuously or batchwise. The polymerization is generally carried out at a temperature of between 20° C. and 150° C. and preferably in the vicinity of 30° C. to 110° C.

The second stage of the process according to an embodiment of the invention consists of the modification of the living diene elastomer, obtained on conclusion of the anionic polymerization stage, according to operating conditions which promote the coupling reaction of the diene elastomer with an appropriate functionalization agent. This stage results in the synthesis of a triblock diene elastomer.

The reaction of modification of the living diene elastomer, obtained on conclusion of the first stage, can take place at a temperature of between −20° C. and 100° C., by addition to the living polymer chains or vice versa of a non-polymerizable functionalization agent capable of contributing a polyether block having a number-average molecular weight ranging from 150 to 5000 g/mol, the central block being advantageously bonded to each of the lateral blocks via a silicon atom. This non-polymerizable functionalization agent makes it possible in particular to obtain the structures of formula (I) described above.

Thus, preferably, the functionalization agent corresponds to the following formula (III):

R₁−(A)₂

in which:

R₁ represents a C₁-C₁₅ divalent alkyl, C₆-C₁₅ aryl or C₇-C₁₅ aralkyl hydrocarbon derivative,

each A represents, identically or differently, the group of general formula (IV):

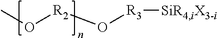

in which:

R₂ represents a divalent C₁-C₁₀ alkyl radical, in particular the —CH(R₆)—CH(R₇)— radical, in which R₆ and R₇ are, independently of one another, a hydrogen atom or a C₁-C₄ alkyl radical,

R₃ represents a C₁-C₅₀ divalent alkyl, C₆-C₅₀ aryl or C₇-C₅₀ aralkyl radical,

R₄ represents a C₁-C₅₀ alkyl, C₆-C₅₀ aryl or C₇-C₅₀ aralkyl radical,

each X represents, identically or differently, one at least of the groups chosen from a halogen atom and a group of formula —OR₅ in which R₅ represents a C₁-C₁₈ alkyl, C₅-C₁₈ cycloalkyl or C₆-C₁₈ aryl radical,

n is a number greater than 1,

i is an integer from 0 to 2.

According to advantageous alternative forms of the invention of the functionalization agent used, which are separate but which can be combined with one another:
R₁ represents a C₁-C₄ alkyl radical, preferably a —CH₂—CH₂— or —CH₂—CH(CH₃)— group,
R₂ is an ethylene or propylene radical, preferably an ethylene radical,
R₃ represents a C₁-C₁₀ alkyl radical, preferably the linear divalent C₃ alkyl radical,
R₄ represents a C₁-C₁₀ alkyl radical, preferably the methyl radical,
X represents, identically or differently, one at least of the groups chosen from a chlorine atom and a group of formula —OR₅ in which R₅ represents a C₁-C₄ alkyl radical, preferably a methyl or ethyl radical,
n is a number of less than 120, preferably a number varying from 2 to 60,
i is an integer equal to 0 or 1.

The polyether block of the functionalization agent used according to an embodiment of the invention preferably exhibits a number-average molecular weight ranging from 150 to 3000 g/mol and better still from 200 to 3000 g/mol.

A person skilled in the art will easily understand, on reading the above formulae (III) and (IV), that there exists, given the valency 2 of the R₁ group, two identical or different groups A in which there exists at least one and at the most three identical or different group(s) X bonded to the polyether block via the silicon atom.

Mention may be made, among the functionalization agents corresponding to the general formula (III), for example, of poly(oxy-1,2-ethanediyl), α-[3-(methoxydimethylsilyl)propyl]-ω-[3-(methoxy-dimethylsilyl)propoxy], poly(oxy-1,2-ethanediyl), α-[3-(dimethoxy-methylsilyl)propyl]-ω-[3-(dimethoxymethylsilyl)propoxy], poly(oxy-1,2-ethanediyl), α-[3-(ethoxydimethylsilyl)propyl]-ω-[3-(ethoxy-dimethylsilyl)propoxy], poly(oxy-1,2-ethanediyl), α-[3-(diethoxy-methylsilyl)propyl]-ω-[3-(diethoxymethylsilyl)propoxy], poly(oxy-1,2-ethanediyl), α-[3-(dichloromethylsilyl)propyl]-ω-[3-(dichloro-methylsilyl)propoxy], poly[oxy(methyl-1,2-ethanediyl)] or α-[3-(dichloromethylsilyl)propyl]-ω-[3-(dichloromethylsilyl)propoxy].

This functionalization agent can either be purchased directly or be prepared according to methods described in the literature, for example consisting in carrying out a first allylation reaction on a polyethylene glycol in the presence of allyl bromide and of a base, such as potassium hydroxide, either in aqueous solution or in a two-phase medium or also in an organic solvent, such as tetrahydrofuran, and then a hydrosilylation reaction, for example by using a platinum catalyst, such as the platinum(0)-1,3-divinyl-1,1,3,3-tetramethyldisiloxane complex or hexachloroplatinic acid, in the presence of a silane, such as chlorodimethylsilane, dichloromethyl-silane or trichlorosilane, or also an alkylalkoxysilane, in the presence or in the absence of solvent.

The mixing of the living diene polymer and the functionalization agent can be carried out by any appropriate means. The time for reaction between the living diene polymer and the coupling agent can be between 10 seconds and 2 hours.

The molar ratio of the functionalization agent to the initiator of the living polymer chains varies from 0.40 to 0.60, preferably from 0.45 to 0.55.

The solvent used for the coupling reaction of the polymer chains, preferably, is the same as the inert hydrocarbon solvent optionally used for the polymerization, and preferably cyclohexane or any other aliphatic hydrocarbon solvent.

According to alternative forms of this process, these stages comprise a stripping stage for the purpose of recovering the elastomer resulting from the prior stages in dry form. Depending on the nature of the —Si—X functions present on the triblock diene elastomer, when the silicon atom of the A group bears more than one reactive site, and on the operating conditions, this stripping stage can in particular have the effect of hydrolysing all or a portion of these functions to give silanol SiOH functions. According to other alternative forms, when the silicon atom of the group A bears more than one halogenated reactive site Si—X, the functionalized reaction can be continued by a stage of hydrolysis or of alcoholysis known per se which makes it possible to generate silanol Si—OH or alkoxysilane Si—OR functions from these halogenated active sites which have not reacted with the living elastomer. This stage of hydrolysis or alcoholysis can be carried out by adding the polymer solution to an aqueous solution or to a solution containing an alcohol or, conversely, by adding the water or the alcohol to the polymer solution. This stage may or may not be carried out in the presence of a base or of a buffer. By way of example, use may be made of an amine, such as triethylamine.

According to other alternative forms, the process can also comprise a stage of intermediate functionalization of the living diene elastomer by a cyclic organosilane, for example hexamethylcyclotrisiloxane, which is carried out (as described in Patent FR 2 918 064 B1) in order to obtain a polymer with a lithium silanolate chain end, before reaction with the functionalization agent of general formula (III). It should be noted that this intermediate functionalization makes it possible to limit the polysubstitution reactions in the case where the functionalization agent of general formula (III) comprises several reactive sites on the same atom. This intermediate functionalization is thus advantageously carried out in this case.

The process of the invention can comprise, according to another alternative form, an additional stage of functionalization, of coupling and/or of star branching, known to a person skilled in the art, employing a compound other than a cyclic organosiloxane and different from the functionalization agent of general formula (III), for example a coupling and/or star-branching agent comprising an atom of Group IV of the Periodic Table of the Elements, such as in particular a tin-based derivative. It should be noted that this additional modification of the diene elastomer can advantageously be carried out in order to regulate the cold flow of the block copolymer of an embodiment of the invention. This modification is advantageously carried out before the stage of modification with the functional polyether.

The stages of these different alternative forms can be combined with one another.

It is known to a person skilled in the art that, during a modification of a living diene elastomer bearing an active site obtained in the anionic polymerization stage by a functionalization agent itself bearing several reactive sites, several elastomeric entities are recovered (elastomer functionalized at the chain end, non-functionalized elastomer, coupled elastomer, star-branched elastomer). The molar ratio of the functionalization agent to the metal of the polymerization initiator makes it possible to adjust and control the proportions of the different entities within the elastomeric mixture. Thus, in the context of an embodiment of the invention, with a ratio of the functionalization agent to the metal of the polymerization initiator varying from 0.40 to 0.60, the formation of coupled entities, then predominant within the modified elastomer, is favoured.

Another subject-matter of the invention is a reinforced rubber composition based on at least one reinforcing filler and an elastomer matrix comprising at least one triblock diene elastomer as described above. It should be understood that the rubber composition can comprise one or more of these triblock diene elastomers according to an embodiment of the invention.

The reinforced rubber composition according to an embodiment of the invention can be provided in the crosslinked state or in the non-crosslinked, in other words crosslinkable, state.

The triblock diene elastomer according to an embodiment of the invention can, according to different alternative forms, be used alone in the composition or as a blend with at least one other conventional diene elastomer, whether it is star-branched, coupled, functionalized or not. Preferably, this other diene elastomer used in an embodiment of the invention is selected from the group of highly unsaturated diene elastomers consisting of polybutadienes (BRs), synthetic polyisoprenes (IRs), natural rubber (NR), butadiene copolymers, isoprene copolymers and the mixtures of these elastomers. Such copolymers are more preferably selected from the group consisting of butadiene/styrene copolymers (SBRs), isoprene/butadiene copolymers (BIRs), isoprene/styrene copolymers (SIRs) and isoprene/butadiene/styrene copolymers (SBIRs). It is also possible to envisage a blend with any synthetic elastomer other than a diene elastomer, indeed even with any polymer other than an elastomer, for example a thermoplastic polymer.

It should be noted that the improvement in the properties of the composition according to an embodiment of the invention will be greater as the proportion of the elastomer(s) different from the triblock diene elastomers of the invention in this composition becomes lower.

Thus, preferably, the elastomer matrix predominantly comprises the triblock diene elastomer according to an embodiment of the invention.

When the conventional elastomer used in blending is natural rubber and/or one or more diene polymers, such as, for example, polybutadienes, polyisoprenes or butadiene/styrene or butadiene/styrene/isoprene copolymers, this elastomer or these elastomers can then be present at from 1 to 70 parts by weight per 100 parts of triblock diene elastomer according to an embodiment of the invention.

More preferably, the elastomer matrix is composed solely of the triblock diene elastomer according to an embodiment of the invention.

The rubber composition of an embodiment of the invention comprises, besides at least one elastomer matrix as described above, at least one reinforcing filler.

Use may be made of any type of reinforcing filler known for its abilities to reinforce a rubber composition which can be used for the manufacture of tire treads, for example carbon black, a reinforcing inorganic filler, such as silica, with which is combined, in a known way, a coupling agent, or also a mixture of these two types of filler.

All carbon blacks, used individually or in the form of mixtures, in particular blacks of the HAF, ISAF or SAF type, conventionally used in the treads of tires (“tire-grade” blacks), are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks. The carbon blacks might, for example, be already incorporated in the isoprene elastomer in the form of a masterbatch (see, for example, Applications WO 97/36724 or WO 99/16600).

“Reinforcing inorganic filler” should be understood, in the present patent application, by definition, as any inorganic or mineral filler, whatever its colour and its origin (natural or synthetic), capable of reinforcing by itself alone, without means other than an intermediate coupling agent, a rubber composition intended for the manufacture of tires; such a filler is generally characterized, in a known way, by the presence of hydroxyl (—OH) groups at its surface.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica exhibiting a BET specific surface and a CTAB specific surface both of less than 450 m²/g, preferably from 30 to 400 m²/g, in particular between 60 and 300 m²/g. Mention will also be made of mineral fillers of the aluminous type, in particular alumina (Al₂O₃) or aluminium (oxide) hydroxides, or else reinforcing titanium oxides, for example described in U.S. Pat. No. 6,610,261 and U.S. Pat. No. 6,747,087. Also suitable as reinforcing fillers are reinforcing fillers of another nature, in particular carbon black, provided that these reinforcing fillers are covered with a siliceous layer or else comprise, at their surface, functional sites, in particular hydroxyl sites, requiring the use of a coupling agent in order to establish the bond between the filler and the elastomer. Mention may be made, by way of example, for example, of carbon blacks for tires, such as described, for example, in patent documents WO 96/37547 and WO 99/28380.

The physical state under which the reinforcing inorganic filler is provided is not important, whether it is in the form of a powder, of microbeads, of granules, of beads or any other appropriate densified form. Of course, the term “reinforcing inorganic filler” is also understood to mean mixtures of different reinforcing fillers, in particular of highly dispersible siliceous fillers as described above.

Preferably, the amount of total reinforcing filler (carbon black and/or other reinforcing filler, such as silica) is between 10 and 200 phr, more preferably between 30 and 150 phr and more preferably still between 70 and 130 phr, the optimum being, in a known way, different according to the specific applications targeted.

According to an alternative form of the invention, the reinforcing filler is predominantly other than carbon black, that is to say that it comprises more than 50% by weight, of the total weight of the filler, of one or more fillers other than carbon black, in particular a reinforcing inorganic filler, such as silica; indeed, it is even exclusively composed of such a filler.

According to this alternative form, when carbon black is also present, it can be used at a content of less than 20 phr, more preferably of less than 10 phr (for example, between 0.5 and 20 phr, in particular from 1 to 10 phr).

According to another alternative form of the invention, use is made of a reinforcing filler predominantly comprising carbon black and optionally silica or another inorganic filler.

When the reinforcing filler comprises a filler requiring the use of a coupling agent in order to establish the bond between the filler and the elastomer, the rubber composition according to an embodiment of the invention in addition conventionally comprises an agent capable of effectively providing this bond. When silica is present in the composition as reinforcing filler, use may be made, as coupling agents, of organosilanes, in particular alkoxysilane polysulphides or mercaptosilanes, or also of at least bifunctional polyorganosiloxanes.

In the composition according to an embodiment of the invention, the content of coupling agent is advantageously less than 20 phr, it being understood that it is generally desirable to use as little as possible of it. Its content is preferably between 0.5 and 12 phr. The presence of the coupling agent depends on the presence of the reinforcing inorganic filler. Its content is easily adjusted by a person skilled in the art according to the content of this filler; it is typically of the order of 0.5% to 15% by weight, with respect to the amount of reinforcing inorganic filler other than carbon black.

The rubber composition according to an embodiment of the invention can also comprise, in addition to the coupling agents, coupling activators, agents for covering the fillers or more generally processing aids capable, in a known way, by virtue of an improvement in the dispersion of the filler in the rubber matrix and of a lowering of the viscosity of the composition, of improving its ability to be processed in the raw state, these agents being, for example, hydrolysable silanes, such as alkylalkoxysilanes, polyols, polyethers, primary, secondary or tertiary amines, or hydroxylated or hydrolysable polyorganosiloxanes.

The rubber compositions in accordance with an embodiment of the invention can also comprise reinforcing organic fillers which can replace all or a portion of the carbon blacks or of the other reinforcing inorganic fillers described above. Mention may be made, as examples of reinforcing organic fillers, of functionalized polyvinyl organic fillers, such as described in Applications WO-A-2006/069792, WO-A-2006/069793, WO-A-2008/003434 and WO-A-2008/003435.

The rubber composition according to an embodiment of the invention can also comprise all or a portion of the usual additives generally used in elastomer compositions intended for the manufacture of tires, such as, for example, pigments, non-reinforcing fillers, protective agents, such as antiozone waxes, chemical antiozonants or antioxidants, antifatigue agents, plasticizing agents, reinforcing or plasticizing resins, methylene acceptors (for example, phenolic novolak resin) or methylene donors (for example, HMT or H3M), such as described, for example, in Application WO 02/10269, a crosslinking system based either on sulphur or on sulphur donors and/or on peroxide and/or on bismaleimides, vulcanization accelerators or vulcanization activators.

The composition is manufactured in appropriate mixers, using two successive phases of preparation well known to a person skilled in the art: a first phase of thermomechanical working or kneading (“non-productive” phase) at high temperature, up to a maximum temperature of between 110° C. and 190° C., preferably between 130° C. and 180° C., followed by a second phase of mechanical working (“productive” phase) down to a lower temperature, typically of less than 110° C., for example between 40° C. and 100° C., during which finishing phase the crosslinking system is incorporated.

The process for the preparation of a composition according to an embodiment of the invention generally comprises:

(i) the implementation, at a maximum temperature of between 130° C. and 200° C., of a first step of thermomechanical working of the constituents of the composition comprising the triblock diene elastomer according to an embodiment of the invention and a reinforcing filler, with the exception of a crosslinking system, then

(ii) the implementation, at a temperature lower than the said maximum temperature of the said first step, of a second step of mechanical working during which the said crosslinking system is incorporated.

This process can also comprise, prior to the implementation of the abovementioned stages (i) and (ii), the stages of the preparation of the triblock diene elastomer.

Another subject-matter of an embodiment of the invention is a semi-finished article made of rubber for a tire, comprising a rubber composition according to an embodiment of the invention which is crosslinkable or crosslinked or composed of such a composition.

The final composition thus obtained can subsequently be calendered, for example in the form of a sheet or a plaque or also extruded, for example in order to form a rubber profiled element which can be used as a semi-finished rubber product intended for the tire. Such a semi-finished product also forms the subject-matter of the invention.

Due to the improvement in the hysteresis/raw processing/stiffness compromise which characterizes a reinforced rubber composition according to an embodiment of the invention, it should be noted that such a composition can constitute any semi-finished product of the tire and very particularly the tread, reducing in particular its rolling resistance and improving its wear resistance.

A final subject-matter of the invention is thus a tire comprising a semi-finished article according to an embodiment of the invention, in particular a tread.

The abovementioned characteristics of the present invention, and also others, will be better understood on reading the following description of several implementational examples of the invention, given by way of illustration and without limitation.

### EXAMPLES

### Examples of the Preparation of Modified Elastomers

### Preparation of the Polymer A

### SBR Non-Functional—Control

1.8 kg of styrene and 4.9 kg of butadiene, and also 395 ml of a 0.1 mol·l⁻¹ solution of tetrahydrofurfuryl ether in methylcyclohexane, are injected into a 90-litre reactor, maintained under a nitrogen pressure of approximately 2 bar, containing 44.7 kg of methylcyclohexane. After neutralization of the impurities in the solution to be polymerized by addition of n-butyllithium, 535 ml of 0.05 mol·l⁻¹ n-butyllithium in methylcyclohexane are added. The polymerization is carried out at 50° C.

After 40 minutes, the degree of conversion of the monomers reaches 90%. This content is determined by weighing an extract dried at 140° C. under a reduced pressure of 200 mmHg. 530 ml of a 0.15 mol·l⁻¹ solution of methanol in toluene are then added. The solution is subsequently antioxidized by addition of 0.8 part per hundred parts of elastomer (phr) of 4,4′-methylenebis(2,6-di(tert-butyl)phenol) and 0.2 part per hundred parts of elastomer (phr) of N-(1,3-dimethylbutyl)-N′-phenyl-p-phenylenediamine. The copolymer thus treated is separated from its solution by a steam stripping operation and then dried on open mills at 100° C. for 15 minutes.

The Mooney viscosity of the polymer is 60.

The number-average molar mass Mₙ of this copolymer, determined by the SEC technique, is 192 000 g·mol⁻¹ and the polydispersity index PI is 1.07.

The microstructure of this copolymer is determined by the NIR method. The content of 1,2-units is 59%, with respect to the butadiene units. The content by weight of styrene is 25%.

The glass transition temperature of this copolymer is −24° C.

### Preparation of the Polymer B

### SBR Amine-Functional at the Chain End—Control

1.8 kg of styrene and 4.9 kg of butadiene, and also 395 ml of a 0.1 mol·l⁻¹ solution of tetrahydrofurfuryl ether in methylcyclohexane, are injected into a 90-litre reactor, maintained under a nitrogen pressure of approximately 2 bar, containing 44.7 kg of methylcyclohexane. After neutralization of the impurities in the solution to be polymerized by addition of n-butyllithium, 1.07 l of 0.05 mol·l⁻¹ lithium hexamethyleneamine in methylcyclohexane are added. The polymerization is carried out at 50° C.

After 32 minutes, the degree of conversion of the monomers reaches 90%. This content is determined by weighing an extract dried at 140° C. under a reduced pressure of 200 mmHg. A control sample is then withdrawn from the reactor and then stopped with an excess of methanol with respect to the lithium. The intrinsic viscosity (“initial” viscosity), which is measured at 0.1 g·l⁻¹ in toluene at 25° C., is 1.10 dl·g⁻¹. 268 ml of a 0.1 mol·l⁻¹ solution of dimethyldichlorosilane in methylcyclohexane are added. After reacting at 50° C. for 20 minutes, the solution is antioxidized by addition of 0.8 part per hundred parts of elastomer (phr) of 4,4′-methylenebis(2,6-di(tert-butyl)phenol) and 0.2 part per hundred parts of elastomer (phr) of N-(1,3-dimethylbutyl)-N′-phenyl-p-phenylenediamine. The copolymer thus treated is separated from its solution by a steam stripping operation and then dried on open mills at 100° C. for 15 minutes.

The “final” intrinsic viscosity measured is 1.80 dl·g⁻¹. The jump in viscosity, defined as the ratio of the said “final” viscosity to the said “initial” viscosity, is in this instance 1.63. The Mooney viscosity of the polymer thus coupled is 59.

The number-average molar mass Mₙ of this copolymer, determined by the SEC technique, is 188 000 g·mol⁻¹ and the polydispersity index PI is 1.09.

The microstructure of this copolymer is determined by the NIR method. The content of 1,2-units is 60%, with respect to the butadiene units. The content by weight of styrene is 25%.

The glass transition temperature of this copolymer is −24° C.

### Preparation of the Polymer C

### SBR Silanol+Polyether-Functional in the Middle of the Chain—Control

1.8 kg of styrene and 4.9 kg of butadiene, and also 395 ml of a 0.1 mol·l⁻¹ solution of tetrahydrofurfuryl ether in methylcyclohexane, are injected into a 90-litre reactor, maintained under a nitrogen pressure of approximately 2 bar, containing 44.7 kg of methylcyclohexane. After neutralization of the impurities in the solution to be polymerized by addition of n-butyllithium, 1.07 l of 0.05 mol·l⁻¹ n-butyllithium in methylcyclohexane are added. The polymerization is carried out at 50° C.

After 30 minutes, the degree of conversion of the monomers reaches 90%. This content is determined by weighing an extract dried at 140° C. under a reduced pressure of 200 mmHg. A control sample is then withdrawn from the reactor and then stopped with an excess of methanol with respect to the lithium. The intrinsic viscosity (“initial” viscosity), which is measured at 0.1 g·dl⁻¹ in toluene at 25° C., is 1.10 dl·g⁻¹. 268 ml of a 0.1 mol·l⁻¹ solution of poly(oxy-1,2-ethanediyl), α-[3-(dichloromethylsilyl)propyl]-ω-[3-(dichloromethyl-silyl)propoxy], in diethyl ether are added. After reacting at 50° C. for 90 minutes, an excess of water is added in order to neutralize the SiCl functions present on the polymer chains. The solution is subsequently antioxidized by addition of 0.8 part per hundred parts of elastomer (phr) of 4,4′-methylenebis(2,6-di(tert-butyl)phenol) and 0.2 part per hundred parts of elastomer (phr) of N-(1,3-dimethylbutyl)-N′-phenyl-p-phenylenediamine. The copolymer thus treated is separated from its solution by a steam stripping operation and then dried on open mills at 100° C. for 15 minutes.

The “final” intrinsic viscosity measured is 1.76 dl·g⁻¹. The jump in viscosity, defined as the ratio of the said “final” viscosity to the said “initial” viscosity, is in this instance 1.60. The Mooney viscosity of the polymer thus coupled is 59.

The number-average molar mass Mₙ of this copolymer, determined by the SEC technique, is 186 000 g·mol⁻¹ and the polydispersity index PI is 1.15.

The microstructure of this copolymer is determined by the NIR method. The content of 1,2-units is 60%, with respect to the butadiene units. The content by weight of styrene is 25%.

The glass transition temperature of this copolymer is −24° C.

### Preparation of the Polymer D

### SBR Silanol-Functional in the Middle of the Chain—Control

1.8 kg of styrene and 4.9 kg of butadiene, and also 395 ml of a 0.1 mol·l⁻¹ solution of tetrahydrofurfuryl ether in methylcyclohexane, are injected into a 90-litre reactor, maintained under a nitrogen pressure of approximately 2 bar, containing 44.7 kg of methylcyclohexane. After neutralization of the impurities in the solution to be polymerized by addition of n-butyllithium, 1.07 l of 0.05 mol·l⁻¹ n-butyllithium in methylcyclohexane are added. The polymerization is carried out at 50° C.

After 30 minutes, the degree of conversion of the monomers reaches 90%. This content is determined by weighing an extract dried at 140° C. under a reduced pressure of 200 mmHg. A control sample is then withdrawn from the reactor and then stopped with an excess of methanol with respect to the lithium. The intrinsic viscosity (“initial” viscosity), which is measured at 0.1 g·l⁻¹ in toluene at 25° C., is 1.10 dl·g⁻¹. 268 ml of a 0.1 mol·l⁻¹ solution of methyltrichlorosilane in methylcyclohexane are added. After reacting at 0° C. for 20 minutes, an excess of water is added in order to hydrolyse the SiCl functions present on the polymer chains. The solution is subsequently antioxidized by addition of 0.8 part per hundred parts of elastomer (phr) of 4,4′-methylenebis(2,6-di(tert-butyl)phenol) and 0.2 part per hundred parts of elastomer (phr) of N-(1,3-dimethylbutyl)-N′-phenyl-p-phenylenediamine. The copolymer thus treated is separated from its solution by a steam stripping operation and then dried on open mills at 100° C. for 15 minutes.

The “final” intrinsic viscosity measured is 1.80 dl·g⁻¹. The jump in viscosity, defined as the ratio of the said “final” viscosity to the said “initial” viscosity, is in this instance 1.64. The Mooney viscosity of the polymer thus coupled is 60.

The number-average molar mass Mₙ of this copolymer, determined by the SEC technique, is 190 000 g·mol⁻¹ and the polydispersity index PI is 1.10.

The percentage by weight of coupled entities, determined by the high resolution SEC technique, is 82%.

The microstructure of this copolymer is determined by the NIR method. The content of 1,2-units is 60%, with respect to the butadiene units. The content by weight of styrene is 25%.

The glass transition temperature of this copolymer is −24° C.

### Preparation of the Polymer E

### SBR Aminoalkoxysilane-Functional in the Middle of the Chain—Control

1.8 kg of styrene and 4.9 kg of butadiene, and also 395 ml of a 0.1 mol·l⁻¹ solution of tetrahydrofurfuryl ether in methylcyclohexane, are injected into a 90-litre reactor, maintained under a nitrogen pressure of approximately 2 bar, containing 44.7 kg of methylcyclohexane. After neutralization of the impurities in the solution to be polymerized by addition of n-butyllithium, 1.07 l of 0.05 mol·l⁻¹ n-butyllithium in methylcyclohexane are added. The polymerization is carried out at 50° C.

After 30 minutes, the degree of conversion of the monomers reaches 90%. This content is determined by weighing an extract dried at 140° C. under a reduced pressure of 200 mmHg. A control sample is then withdrawn from the reactor and then stopped with an excess of methanol with respect to the lithium. The intrinsic viscosity (“initial” viscosity), which is measured at 0.1 g·dl⁻¹ in toluene at 25° C., is 1.11 dl·g⁻¹. 268 ml of a 0.1 mol·l⁻¹ solution of (3-N,N-dimethylaminopropyl)trimethoxysilane in methylcyclohexane are added. After reacting at 50° C. for 20 minutes, the solution is subsequently antioxidized by addition of 0.8 part per hundred parts of elastomer (phr) of 4,4′-methylenebis(2,6-di(tert-butyl)phenol) and 0.2 part per hundred parts of elastomer (phr) of N-(1,3-dimethylbutyl)-N′-phenyl-p-phenylenediamine. The copolymer thus treated is separated from its solution by a steam stripping operation and then dried on open mills at 100° C. for 15 minutes.

The “final” intrinsic viscosity measured is 1.78 dl·g⁻¹. The jump in viscosity, defined as the ratio of the said “final” viscosity to the said “initial” viscosity, is in this instance 1.60. The Mooney viscosity of the polymer thus coupled is 59.

The number-average molar mass Mₙ of this copolymer, determined by the SEC technique, is 187 000 g·mol⁻¹ and the polydispersity index PI is 1.13.

The percentage by weight of coupled entities, determined by the high resolution SEC technique, is 85%.

The microstructure of this copolymer is determined by the NIR method. The content of 1,2-units is 60%, with respect to the butadiene units. The content by weight of styrene is 25%.

The glass transition temperature of this copolymer is −24° C.

### Preparation of the Polymer F

### SBR Epoxide+Alkoxysilane-Functional in the Middle of the Chain—Control

1.8 kg of styrene and 4.9 kg of butadiene, and also 395 ml of a 0.1 mol·l⁻¹ solution of tetrahydrofurfuryl ether in methylcyclohexane, are injected into a 90-litre reactor, maintained under a nitrogen pressure of approximately 2 bar, containing 44.7 kg of methylcyclohexane. After neutralization of the impurities in the solution to be polymerized by addition of n-butyllithium, 1.07 l of 0.05 mol·l⁻¹ n-butyllithium in methylcyclohexane are added. The polymerization is carried out at 50° C.

After 30 minutes, the degree of conversion of the monomers reaches 90%. This content is determined by weighing an extract dried at 140° C. under a reduced pressure of 200 mmHg. A control sample is then withdrawn from the reactor and then stopped with an excess of methanol with respect to the lithium. The intrinsic viscosity (“initial” viscosity), which is measured at 0.1 g·dl⁻¹ in toluene at 25° C., is 1.10 dl·g⁻¹. 268 ml of a 0.1 mol·l⁻¹ solution of (3-glycidyloxypropyl)trimethoxy silane in methylcyclohexane are added. After reacting at 50° C. for 20 minutes, the solution is subsequently antioxidized by addition of 0.8 part per hundred parts of elastomer (phr) of 4,4′-methylenebis(2,6-di(tert-butyl)phenol) and 0.2 part per hundred parts of elastomer (phr) of N-(1,3-dimethylbutyl)-N′-phenyl-p-phenylenediamine. The copolymer thus treated is separated from its solution by a steam stripping operation and then dried on open mills at 100° C. for 15 minutes.

The “final” intrinsic viscosity measured is 1.77 dl·g⁻¹. The jump in viscosity, defined as the ratio of the said “final” viscosity to the said “initial” viscosity, is in this instance 1.61. The Mooney viscosity of the polymer thus coupled is 58.

The number-average molar mass Mₙ of this copolymer, determined by the SEC technique, is 186 000 g·mol⁻¹ and the polydispersity index PI is 1.14.

The percentage by weight of coupled entities, determined by the high resolution SEC technique, is 86%.

The microstructure of this copolymer is determined by the NIR method. The content of 1,2-units is 60%, with respect to the butadiene units. The content by weight of styrene is 25%.

The glass transition temperature of this copolymer is −24° C.

### Preparation of the Polymer G

### SBR Silanol-Functional at the Chain End—Control

1.8 kg of styrene and 4.9 kg of butadiene, and also 395 ml of a 0.1 mol·l⁻¹ solution of tetrahydrofurfuryl ether in methylcyclohexane, are injected into a 90-litre reactor, maintained under a nitrogen pressure of approximately 2 bar, containing 44.7 kg of methylcyclohexane. After neutralization of the impurities in the solution to be polymerized by addition of n-butyllithium, 535 ml of 0.05 mol·l⁻¹ n-butyllithium in methylcyclohexane are added. The polymerization is carried out at 50° C.

After 40 minutes, the degree of conversion of the monomers reaches 90%. This content is determined by weighing an extract dried at 140° C. under a reduced pressure of 200 mmHg. 134 ml of a 0.1 mol·l⁻¹ solution of hexamethylcyclotrisiloxane in methylcyclohexane are then added. After 30 minutes at 60° C., 535 ml of a 0.15 mol·l⁻¹ solution of methanol in toluene are then added. The solution is subsequently antioxidized by addition of 0.8 part per hundred parts of elastomer (phr) of 4,4′-methylenebis(2,6-di(tert-butyl)phenol) and 0.2 part per hundred parts of elastomer (phr) of N-(1,3-dimethylbutyl)-N′-phenyl-p-phenylenediamine. The copolymer thus treated is separated from its solution by a steam stripping operation and then dried on open mills at 100° C. for 15 minutes.

The Mooney viscosity of the polymer is 59.

The number-average molar mass Mₙ of this copolymer, determined by the SEC technique, is 190 000 g·mol⁻¹ and the polydispersity index PI is 1.05.

The microstructure of this copolymer is determined by the NIR method. The content of 1,2-units is 59%, with respect to the butadiene units. The content by weight of styrene is 25%.

The glass transition temperature of this copolymer is −24° C.

### Preparation of the Polymer H

### SBR Amine-Functional at the Chain End and Silanol+Polyether-Functional in the Middle of the Chain According to an Embodiment of the Invention

1.8 kg of styrene and 4.9 kg of butadiene, and also 395 ml of a 0.1 mol·l⁻¹ solution of tetrahydrofurfuryl ether in methylcyclohexane, are injected into a 90-litre reactor, maintained under a nitrogen pressure of approximately 2 bar, containing 44.7 kg of methylcyclohexane. After neutralization of the impurities in the solution to be polymerized by addition of n-butyllithium, 1.07 l of 0.05 mol·l⁻¹ lithium hexamethyleneamine in methylcyclohexane are added. The polymerization is carried out at 50° C.

After 30 minutes, the degree of conversion of the monomers reaches 90%. This content is determined by weighing an extract dried at 140° C. under a reduced pressure of 200 mmHg. A control sample is then withdrawn from the reactor and then stopped with an excess of methanol with respect to the lithium. The intrinsic viscosity (“initial” viscosity), which is measured at 0.1 g·dl⁻¹ in toluene at 25° C., is 1.09 dl·g⁻¹. 268 ml of a 0.1 mol·l⁻¹ solution of poly(oxy-1,2-ethanediyl), α-[3-(dichloromethylsilyl)propyl]-ω-[3-(dichloromethyl-silyl)propoxy], in diethyl ether are added. After reacting at 50° C. for 90 minutes, an excess of water is added in order to neutralize the SiCl functions present on the polymer chains. The solution is subsequently antioxidized by addition of 0.8 part per hundred parts of elastomer (phr) of 4,4′-methylenebis(2,6-di(tert-butyl)phenol) and 0.2 part per hundred parts of elastomer (phr) of N-(1,3-dimethylbutyl)-N′-phenyl-p-phenylenediamine. The copolymer thus treated is separated from its solution by a steam stripping operation and then dried on open mills at 100° C. for 15 minutes.

The “final” intrinsic viscosity measured is 1.74 dl·g⁻¹. The jump in viscosity, defined as the ratio of the said “final” viscosity to the said “initial” viscosity, is in this instance 1.60. The Mooney viscosity of the polymer thus coupled is 58.

The number-average molar mass Mₙ of this copolymer, determined by the SEC technique, is 183 000 g·mol⁻¹ and the polydispersity index PI is 1.15.

The microstructure of this copolymer is determined by the NIR method. The content of 1,2-units is 60%, with respect to the butadiene units. The content by weight of styrene is 25%.

The glass transition temperature of this copolymer is −24° C.

Measurements and Tests Used

Size Exclusion Chromatography

The SEC (Size Exclusion Chromatography) technique makes it possible to separate macromolecules in solution according to their size through columns filled with a porous gel. The macromolecules are separated according to their hydrodynamic volume, the bulkiest being eluted first.

Without being an absolute method, SEC makes it possible to comprehend the distribution of the molar masses of a polymer. The various number-average molar masses (Mn) and weight-average molar masses (Mw) can be determined from commercial standards and the polydispersity index (PI=Mw/Mn) can be calculated via a “Moore” calibration.

There is no specific treatment of the polymer sample before analysis. The latter is simply dissolved in the elution solvent at a concentration of approximately 1 g·l⁻¹. The solution is then filtered through a filter with a porosity of 0.45 μm before injection.

The apparatus used is a Waters Alliance chromatographic line. The elution solvent is either tetrahydrofuran or tetrahydrofuran +1 vol % of diisopropylamine+1 vol % of triethylamine, the flow rate is 1 ml·min⁻¹, the temperature of the system is 35° C. and the analytical time is 30 min. A set of two Waters columns with the Styragel HT6E trade name is used. The volume of the solution of the polymer sample injected is 100 μl. The detector is a Waters 2410 differential refractometer and the software for making use of the chromatographic data is the Waters Empower system.

The calculated average molar masses are relative to a calibration curve produced for SBRs having the following microstructure: 25% by weight of units of styrene type, 23% by weight of units of 1,2-type and 50% by weight of units of trans-1,4-type.

High-Resolution Size Exclusion Chromatography

The high-resolution SEC technique is used to determine the percentages by weight of the various populations of chains present in a polymer sample.

There is no specific treatment of the polymer sample before analysis. The latter is simply dissolved in the elution solvent at a concentration of approximately 1 g·l⁻¹. The solution is then filtered through a filter with a porosity of 0.45 μm before injection.

The apparatus used is a Waters Alliance 2695 chromatographic line. The elution solvent is tetrahydrofuran, the flow rate is 0.2 ml·min⁻¹ and the temperature of the system is 35° C. A set of three identical columns in series is used (Shodex, length 300 mm, diameter 8 mm). The number of theoretical plates of the set of columns is greater than 22 000. The volume of the solution of the polymer sample injected is 50 μl. The detector is a Waters 2414 differential refractometer and the software for making use of the chromatographic data is the Waters Empower system.

The calculated molar masses are relative to a calibration curve produced for SBRs having the following microstructure: 25% by weight of units of styrene type, 23% by weight of units of 1,2-type and 50% by weight of units of trans-1,4-type.

Mooney Viscosity

For the polymers and rubber compositions, the Mooney viscosities ML₍₁₊₄₎100°) C. are measured according to Standard ASTM D-1646.

Use is made of an oscillating consistometer as described in Standard ASTM D-1646. The Mooney plasticity measurement is carried out according to the following principle: the composition in the raw state (i.e., before curing) is moulded in a cylindrical chamber heated to 100° C. After preheating for one minute, the rotor rotates within the test specimen at 2 revolutions/minute and the working torque for maintaining this movement after rotating for 4 minutes is measured. The Mooney plasticity ML₍₁₊₄₎ is expressed in “Mooney unit” (MU, with 1 MU=0.83 N·m).

Differential Calorimetry

The glass transition temperatures (Tg) of the elastomers are determined using a differential scanning calorimeter.

Near-Infrared (NIR) Spectroscopy

The microstructure of the elastomers is characterized by the near-infrared (NIR) spectroscopy technique.

Near-infrared spectroscopy (NIR) is used to quantitatively determine the content by weight of styrene in the elastomer and also its microstructure (relative distribution of the 1,2-, trans-1,4- and cis-1,4-butadiene units). The principle of the method is based on the Beer-Lambert law generalized for a multicomponent system. As the method is indirect, it involves a multivariate calibration [Vilmin, F., Dussap, C. and Coste, N., Applied Spectroscopy, 2006, 60, 619-29] carried out using standard elastomers having a composition determined by ¹³C NMR. The styrene content and the microstructure are then calculated from the NIR spectrum of an elastomer film having a thickness of approximately 730 μm. The spectrum is acquired in transmission mode between 4000 and 6200 cm⁻¹ with a resolution of 2 cm⁻¹ using a Bruker Tensor 37 Fourier-transform near-infrared spectrometer equipped with an InGaAs detector cooled by the Peltier effect.

Intrinsic Viscosity

The intrinsic viscosity of the elastomers at 25° C. is determined from a 0.1 g·dl⁻¹ solution of elastomer in toluene, according to the following principle:

The intrinsic viscosity is determined by the measurement of the flow time t of the polymer solution and of the flow time tₒ of the toluene in a capillary tube.

The flow time of the toluene and the flow time of the 0.1 g·dl⁻¹ polymer solution are measured in an Ubbelohde tube (diameter of the capillary 0.46 mm, capacity from 18 to 22 ml) placed in a bath thermostatically controlled at 25-0.1° C.

The intrinsic viscosity is obtained by the following relationship:

$${h}_{inh} = \frac{1}{C} ln [ \frac{( t )}{( {t}_{0} )} ]$$

with:
C: concentration of the solution of polymer in toluene in g·dl⁻¹,
t: flow time of the solution of polymer in toluene in seconds,
tₒ: flow time of the toluene in seconds,
hᵢₙₕ: intrinsic viscosity, expressed in dl·g⁻¹.

Dynamic Properties

The dynamic properties G* and tan δ max are measured on a viscosity analyser (Metravib VA4000) according to Standard ASTM D 5992-96. The response of a sample of vulcanized composition (cylindrical test specimen with a thickness of 2 mm and a cross-section of 79 mm²), subjected to a simple alternating sinusoidal shear stress, at a frequency of 10 Hz, under standard temperature conditions (40° C.) according to Standard ASTM D 1349-99, is recorded. A strain amplitude sweep is carried out from 0.1% to 50% peak-to-peak (outward cycle) and then from 50% to 0.1% peak-to-peak (return cycle). The results made use of are the complex dynamic shear modulus (G*) and the loss factor tan 6. For the return cycle, the maximum value of tan 6 observed, denoted tan 6 max, is indicated. This value is representative of the hysteresis of the material and in the present case of the rolling resistance: the smaller the value of tan 6 max, the lower the rolling resistance. The G* values, measured to 40° C., are representative of the stiffness, that is to say of the resistance to deformation: the higher the value of G*, the greater the stiffness of the material and thus the higher the wear resistance.

Comparative Examples of Rubber Compositions

Eight compositions given in Table 1 below are compared.

Seven of them (compositions 2 to 8) are not in accordance with regard to the composition recommended by an embodiment of the invention:

TABLE 1

| | Ex- | | | | | | | |
|---|---|---|---|---|---|---|---|---|
| | ample | Comparative examples | | | | | | |
| | 1 | 2 | 3 | 4 | 5 | 6 | 7 | 8 |
| Polymer A | | 100 | | | | | | |
| Polymer B | | | 100 | | | | | |
| Polymer C | | | | 100 | | | | |
| Polymer D | | | | | 100 | | | |
| Polymer E | | | | | | 100 | | |
| Polymer F | | | | | | | 100 | |
| Polymer G | | | | | | | | 100 |
| Polymer H | 100 | | | | | | | |
| Silica (1) | 80 | 80 | 80 | 80 | 80 | 80 | 80 | 80 |
| N234 | 1 | 1 | 1 | 1 | 1 | 1 | 1 | 1 |
| MES Oil (2) | 15 | 15 | 15 | 15 | 15 | 15 | 15 | 15 |
| Resin (3) | 15 | 15 | 15 | 15 | 15 | 15 | 15 | 15 |
| Coupling | 6.4 | 6.4 | 6.4 | 6.4 | 6.4 | 6.4 | 6.4 | 6.4 |
| agent (4) | | | | | | | | |
| ZnO | 2.5 | 2.5 | 2.5 | 2.5 | 2.5 | 2.5 | 2.5 | 2.5 |
| Stearic acid | 2 | 2 | 2 | 2 | 2 | 2 | 2 | 2 |
| Antioxidant | 1.9 | 1.9 | 1.9 | 1.9 | 1.9 | 1.9 | 1.9 | 1.9 |
| (5) | | | | | | | | |
| Antiozone | 1.5 | 1.5 | 1.5 | 1.5 | 1.5 | 1.5 | 1.5 | 1.5 |
| wax C32ST | | | | | | | | |
| (6) | | | | | | | | |
| Diphenyl- | 1.5 | 1.5 | 1.5 | 1.5 | 1.5 | 1.5 | 1.5 | 1.5 |
| guanidine | | | | | | | | |
| Sulphur | 1.2 | 1.2 | 1.2 | 1.2 | 1.2 | 1.2 | 1.2 | 1.2 |
| Sulphena- | 2 | 2 | 2 | 2 | 2 | 2 | 2 | 2 |
| mide | | | | | | | | |
| (7) | | | | | | | | |

(1) Silica Zeosil 1165MP from Rhodia.
(2) Catenex ® SBR from Shell.
(3) Polylimonene.
(4) “Si69” from Degussa.
(5) N-(1,3-Dimethylbutyl)-N′-phenyl-p-phenylenediamine.
(6) Antiozone from Repsol.
(7) N-Cyclohexyl-2-benzothiazolesulphenamide.

The following procedure is used for the tests which follow:

Each of the compositions is produced, in a first step, by thermomechanical working and then, in a second finishing step, by mechanical working.

The elastomer, two-thirds of the silica, the coupling agent, the diphenylguanidine and the carbon black are introduced into a laboratory internal mixer of “Banbury” type which has a capacity of 400 cm³, which is 72% filled and which has an initial temperature of 90° C.

The thermomechanical working is carried out by means of blades, the mean speed of which is 50 rev/min and the temperature of which is 90° C.

After one minute, the final one-third of the silica, the antioxidant, the stearic acid, the antiozone wax, the MES oil and the resin are introduced, still under thermomechanical working.

After two minutes, the zinc oxide is introduced, the speed of the blades being 50 rev/min.

The thermomechanical working is carried out for a further two minutes, up to a maximum dropping temperature of approximately 160° C.

The mixture thus obtained is recovered and cooled and then, in an external mixer (homofinisher), the sulphur and the sulphenamide are added at 30° C., the combined mixture being further mixed for a time of 3 to 4 minutes (second step of mechanical working).

The compositions thus obtained are subsequently calendered, either in the form of plaques (with a thickness ranging from 2 to 3 mm) or thin sheets of rubber, for the measurement of their physical or mechanical properties, or in the form of profiled elements which can be used directly, after cutting and/or assembling to the desired dimensions, for example as semi-finished products for tires, in particular for treads.

Crosslinking is carried out at 150° C. for 40 min.

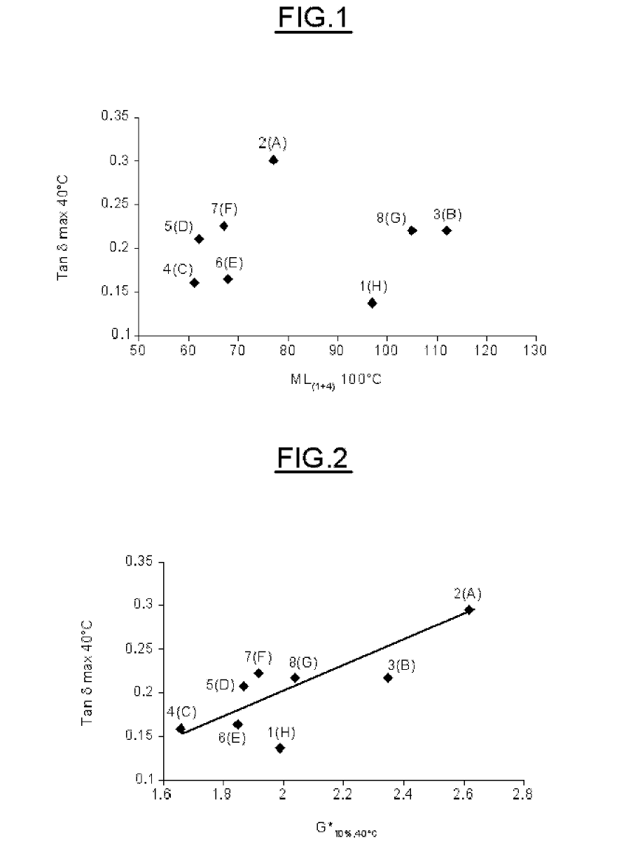

The results are presented in Table 2 and in FIGS. 1 and 2.

TABLE 2
Rubber results (tan d max 40° C., G*_{10%,40° C.}, ML₍₁₊₄₎100° C.):

| | Example | Comparative examples | | | | | | |
|---|---|---|---|---|---|---|---|---|
| | 1 | 2 | 3 | 4 | 5 | 6 | 7 | 8 |
| Tan δ max 40° C. | 0.137 | 0.3 | 0.22 | 0.16 | 0.21 | 0.165 | 0.225 | 0.22 |
| G*_{10%,40° C.} | 2.0 | 2.62 | 2.35 | 1.66 | 1.87 | 1.85 | 1.92 | 2.04 |
| ML₍₁₊₄₎ 100° C. | 97 | 77 | 112 | 61 | 62 | 68 | 67 | 105 |

FIG. 1 shows that composition 1, comprising the SBR which is amine-functional at the chain end and silanol+polyether-functional in the middle of the chain H, exhibits a lower tan δ max 40° C. value than composition 2 comprising control polymer A (non-functional), than composition 3 comprising control polymer B (amine-functional at the chain end) and than compositions 4, 5, 6, 7 and 8 respectively comprising control polymer C (silanol+polyether-functional in the middle of the chain), polymer D (silanol-functional in the middle of the chain), polymer E (aminoalkoxysilane-functional in the middle of the chain), polymer F (alkoxysilane+epoxide-functional in the middle of the chain) and polymer G (silanol-functional at the chain end). This reflects an improved hysteresis.

Nevertheless, the processing of composition 1 remains entirely acceptable, in particular in the light of composition A, which comprises a non-functional elastomer generally used in the formulations for semi-finished products intended for the preparation of tires.

FIG. 2 shows that composition 1 exhibits a tan 6 max 40° C./G^{*}_{10%,40° C.} compromise which is offset with respect to the other compositions and in particular with respect to composition 4 comprising the control polymer C (silanol+polyether-functional in the middle of the chain). This reflects an improved stiffness/hysteresis compromise for composition 1 comprising the triblock polymer according to an embodiment of the invention.

1. A triblock diene elastomer, the central block of which is a polyether block having a number-average molecular weight ranging from 150 to 5000 g/mol and is connected via a silicon atom to each of the lateral blocks, and the chain ends of which are functionalized to at least 70 mol %, with respect to the number of moles of chain end, by an amine function.

2. A triblock diene elastomer according to claim 1, wherein the triblock diene elastomer corresponds to the following formula (I):
R₁-(A′)₂
in which:
R₁ represents a C₁-C₁₅ divalent alkyl, C₆-C₁₅ aryl or C₇-C₁₅ aralkyl hydrocarbon derivative,
each A′ represents, identically or differently, the group of general formula (II): 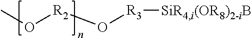
in which:
R₂ represents a divalent C₁-C₁₀ alkyl radical, in particular the —CH(R₆)—CH(R₇)— radical, in which R₆ and R₇ are, independently of one another, a hydrogen atom or a C₁-C₄ alkyl radical,
R₃ represents a C₁-C₅₀ divalent alkyl, C₆-C₅₀ aryl or C₇-C₅₀ aralkyl radical,
R₄ represents a C₁-C₅₀ alkyl, C₆-C₅₀ aryl or C₇-C₅₀ aralkyl radical,
R₈ represents a hydrogen atom or a C₁-C₁₈ alkyl, C₅-C₁₈ cycloalkyl or C₆-C₁₈ aryl radical,
n is a number greater than 1,
i is an integer varying from 0 to 2,
B represents the —[(O—SiR₉R₁₀)_{q}—P] group, in which R₉ and R₁₀ represent, independently of one another, a C₁-C₅₀ alkyl, C₆-C₅₀ aryl or C₇-C₆₀ aralkyl radical, q is an integer ranging from 0 to 10 and P is a diene elastomer functionalized to at least 70 mol % at the chain end by an amine function.

3. Triblock diene elastomer according to claim 2, wherein R₁ represents a C₁-C₄ alkyl radical.

4. A triblock diene elastomer according to claim 2, wherein R₂ is an ethylene or propylene radical.

5. A triblock diene elastomer according to claim 2, wherein R₃ represents a C₁-C₁₀ alkyl group.

6. A triblock diene elastomer according to claim 2, wherein R₄ represents a C₁-C₁₀ alkyl radical.

7. A triblock diene elastomer according to claim 2, wherein R₈ represents a hydrogen atom or a C₁-C₄ alkyl radical.

8. A triblock diene elastomer according to claim 2, n is a number of less than 120.

9. A triblock diene elastomer according to claim 2, wherein i is an integer equal to 0 or 1.

10. A triblock diene elastomer according to claim 2, whereon R₉ and R₁₀ represent, independently of one another, a C₁-C₁₀ alkyl radical.

11. A triblock diene elastomer according to claim 2, wherein q is a nonzero integer.

12. A triblock diene elastomer according claim 1, wherein the diene elastomer is a copolymer of butadiene and of a vinylaromatic monomer, in particular an SBR.

13. A process for the preparation of a triblock diene elastomer as defined in claim 1, wherein the triblock diene elastomer comprises:
anionic polymerization of at least one conjugated diene monomer in the presence of a polymerization initiator having an amine function,
modification of the living diene elastomer bearing an active site obtained in the preceding stage by a functionalization agent, capable of coupling the elastomer chains, bearing a polyether block having a number-average molecular weight ranging from 150 to 5000 g/mol, with a molar ratio of the functionalization agent to the polymerization initiator with a value ranging from 0.40 to 0.60.

14. A preparation process according to claim 13, wherein the polymerization initiator comprising an amine function is chosen from lithium amides obtained from a secondary amine, and from an organolithium compound.

15. A preparation process according to claim 13, wherein the functionalization agent is represented by the formula (III):
R₁-(A)₂
in which:
R₁ represents a C₁-C₁₅ divalent alkyl, C₆-C₁₅ aryl or C₇-C₁₅ aralkyl hydrocarbon derivative,
each A represents, identically or differently, the group of general formula (IV): 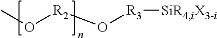
in which:
R₂ represents a divalent C₁-C₁₀ alkyl radical, in particular the —CH(R₆)—CH(R₇)— radical, in which R₆ and R₇ are, independently of one another, a hydrogen atom or a C₁-C₄ alkyl radical,
R₃ represents a C₁-C₅₀ divalent alkyl, C₆-C₅₀ aryl or C₇-C₅₀ aralkyl radical,
R₄ represents a C₁-C₅₀ alkyl, C₆-C₅₀ aryl or C₇-C₅₀ aralkyl radical,
each X represents, identically or differently, one at least of the groups chosen from a halogen atom and a group of formula —OR₅ in which R₅ represents a C₁-C₁₈ alkyl, C₅-C₁₈ cycloalkyl or C₆-C₁₈ aryl radical,
n is a number greater than 1,
i is an integer from 0 to 2.

16. A process according to claim 15, wherein R₁ represents a C₁-C₄ alkyl radical.

17. A process according to claim 15, wherein R₂ is an ethylene or propylene radical.

18. A process according to claim 15, wherein R₃ represents a C₁-C₁₀ alkyl radical.

19. A process according to claim 15, wherein R₄ represents a C₁-C₁₀ alkyl radical.

20. A process according to claim 15, wherein X represents, identically or differently, one at least of the groups chosen from a chlorine atom and a group of formula —OR₅ in which R₅ represents a C₁-C₄ alkyl radical.

21. A process according to claim 15, wherein n is a number of less than 120.

22. A process according to claim 15, wherein i is an integer equal to 0 or 1.

23. A reinforced rubber composition based on at least one reinforcing filler and an elastomer matrix comprising at least one triblock diene elastomer as defined in claim 1.

24. A rubber composition according to claim 23, wherein the elastomer matrix predominantly comprises the triblock diene elastomer.

25. A rubber composition according to claim 23, wherein said reinforcing filler comprises a reinforcing inorganic filler of siliceous type according to a fraction by weight of greater than 50% and ranging up to 100%.

26. A semi-finished article made of rubber for a tire, wherein the semi-finished article comprises a crosslinkable or crosslinked rubber composition according to claim 1.

27. A tire, wherein the tire comprises a semi-finished article as defined in claim 26.

28. A triblock diene elastomer according to claim 3, wherein R₁ represents a —CH₂—CH₂— or —CH₂—CH(CH₃)— group.

29. A triblock diene elastomer according to claim 4, wherein R₂ is an ethylene radical.

30. A triblock diene elastomer according to claim 5, wherein R₃ represents a linear divalent C₃ alkyl radical.

31. A triblock diene elastomer according to claim 6, wherein R₄ represents a methyl radical.

32. A triblock diene elastomer according to claim 7, wherein R₈ represents a hydrogen atom or a methyl or ethyl radical.

33. A triblock diene elastomer according to claim 8, wherein n is a number varying from 2 to 60.

34. A triblock diene elastomer according to claim 10, wherein R₉ and R₁₀ represent, independently of one another, a methyl radical.

35. A triblock diene elastomer according to claim 11, wherein q is equal to 1.

36. A preparation process according to claim 14, wherein the lithium amides are obtained from cyclic secondary amines.
